(19) United States
(12) Patent Application Publication
(10) Pub. No.: US 2008/0216704 A1
(43) Pub. Date: Sep. 11, 2008

(54) Conformal Coating

(75) Inventors: Clyde T. Eisenbeis, Marshalltown, IA (US); Eric W. Strong, Marshalltown, IA (US)

Correspondence Address: MARSHALL, GERSTEIN & BORUN LLP (FISHER), 233 SOUTH WACKER DRIVE, 6300 SEARS TOWER, CHICAGO, IL, 60606, US

(73) Assignee: FISHER CONTROLS INTERNATIONAL LLC, St. Louis, MO (US)

(21) Appl. No.: 11/684,542

(22) Filed: Mar. 9, 2007

(51) Int. Cl. C09K 3/00; B05D 7/00

(52) U.S. Cl. 106/14.05; 427/215

(57) ABSTRACT

A conformal coating comprises a binding layer and a particulate which provides shielding against conductive crystalline structure growth. The particulate comprises materials that provide a tortuous path to substantially inhibit the growth of conductive crystalline structure on electrically conductive surfaces.

### FIELD OF THE INVENTION

This disclosure relates generally to conformal coatings for substrates, and more particularity, to an improved conformal coating to substantially inhibit the effects of metal crystalline structure growth resulting from substantially non-lead-based conductive coatings on electronic assemblies.

### BACKGROUND OF THE INVENTION

A conformal coating is typically a coating material applied to a substrate, such as electronic assembly or electronic circuitry, to provide protection against environmental contaminants such as moisture, dust, chemicals, and temperature extremes. Furthermore, it is generally understood that a suitably chosen conformal coating may reduce the effects of mechanical stress on the electronics assembly thereby substantially reducing the delamination or detachment of components connected to the electronics assembly. Selection of the correct coating material is typically based upon the following criteria: the types of exposure or contaminants the substrate or assembly may experience; the operational temperature range of the substrate or assembly; the physical, electrical, and chemical characteristics of the coating material; and the electrical, chemical, and mechanical compatibility of the coating with the substrate and any components attached to it (i.e., does the coating need to match the coefficient of thermal expansion of the components?). It is generally understood by one of ordinary skill in the art that even though conventional conformal coatings provide adequate protection from typical contaminants, the coatings may provide very little protection against failures related to metallic crystalline structure (e.g. tin whisker) growth.

Since the 1950s, the phenomenon of metallic crystalline structure growth in the electronics industry has been generally known. These formations generally grow from the surface of at least one conductor towards another conductor and may cause electronic system failures by producing short circuits that have bridged closely-spaced conductors or circuit elements operating at different electric potentials. These conductive formations are generally categorized as either dendritic or “whisker” like structures. For example, tin whiskers are known to grow from electroplated tin finishes on electronics assemblies. Tin whiskers are typically characterized as a crystalline metallurgical phenomenon whereby the metal grows tiny, long, thin metal whiskers from a conductor surface. These ‘whisker-like’ structures have been observed to grow outward from conductive surfaces to lengths of several millimeters. This phenomenon has been recorded to occur in both elemental metals and alloys. Other metals that may grow such electrically-conductive whiskers may include Zinc, Cadmium, Indium, Gold, Silver and Antimony. However, it is generally understood that certain lead-based alloys may not exhibit this phenomena.

Presently, there is no definitive explanation as to what specifically causes the formation of metallic whiskers. Some theories suggest that metallic whiskers may grow in response to physical stress imparted during deposition processes such a electroplating and/or from thermal stress in the environment of operation. Further, there is disparity amongst current research regarding the conditions and the specific characteristics of whisker formation. Amongst those conditions are: the requisite incubation period for formation; the specific growth rate of the metallic whiskers; the maximum length of the metallic whiskers; the maximum diameter of whiskers; and the environmental factors that foment growth including temperature, pressure, moisture, thermal cycling in the presence of an electric field. Alternatively, metallic dendrites are better understood.

Metallic dendrites are asymmetric, branching structures with fern-like shape that typically grow across the surface of the metal. Dendrite growth is well characterized as typically occurring in moist conditions that make capable the dissolution of a metal into a solution of metal ions that are redistributed by electro-migration through the presence of an electromagnetic field. Regardless of the type of conductive formation—dendrites or whiskers—these structures may produce electrical short circuits that induce failures in many electronic devices such as sensors, circuit boards or the like. Many attempts have been to made mitigate or substantially prevent such phenomena, and specifically, to mitigate or substantially prevent metallic whisker growth. Conventional methods to avoid tin whisker formation include alloying the tin plating with another metal such as lead or providing a barrier layer such as a conventional conformal coat.

With respect to the first method, the ability to alloy with lead is limited or discouraged by initiatives to remove lead-based compounds from the electronics industry. For example, the European Union (EU) has initiated a program to reduce the use of hazardous materials, such as lead, in the electronics industry. The legislation enacted by the EU is known as the Restriction of certain Hazardous Substances (RoHS) and Waste Electrical and Electronic Equipment (WEEE) Directive. This directive took effect in June 2006 for electronic equipment suppliers and requires the suppliers to eliminate most uses of lead from their products. Thus, the alloying of common electroplating and soldering compositions with lead is no longer a viable solution.

To date, the conformal coating methods have also proved inadequate. Woodrow (T. Woodrow and E. Ledbury, Evaluation of Conformal coatings as a Tin Whisker Mitigation Strategy, IPC/JEDEC 8th International Conference on Lead-Free Electronic Components and Assemblies, San Jose, Calif., Apr. 18-20, 2005.) discusses six different types of typical conformal coatings to mitigate or substantially prevent tin whisker growth. Woodrow's teachings suggest that conventional conformal coatings may suppress the formation of conductive whiskers temporarily, but over time the formations continue to grow and eventually pierce the coating. Further, Woodrow states that “[n]o obvious relationship was noted between the mechanical properties of the coatings and their ability to suppress whisker [formation].” Woodrow's results clearly show that typical conformal coatings do not adequately address the issues of whisker growth in electronics assemblies.

As previously described, substantially non-lead based conductive plating and/or base materials are highly susceptible to the growth of conductive dendritic and/or whisker-like formations that may induce failures in electronic systems. For example, it has been reported that these types of conductive formations has caused satellite failures, (B. Felps, ‘Whiskers’ Caused Satellite Failure: Galaxy IV Outage Blamed On Interstellar Phenomenon, Wireless Week, May 17, 1999.), aircraft failures (Food and Drug Administration, ITG #42: Tin Whiskers-Problems, Causes and Solutions, http://www.fda.gov/ora/inspect_ref/itg/itg42.html, Mar. 16, 1986) and implantable medical device failures (B. Nordwall, Air Force Links Radar Problems to Growth of Tin Whiskers, Aviation Week and Space Technology, Jun. 20, 1986, pp. 65-70.). The present conformal coating creates a composite and/or laminate conformal coating system that may substantially mitigate the growth of conductive crystalline structures. It is generally understood by one of ordinary skill in the art that conventional conformal coatings are typically single phase coatings that will substantially deprive substrates, such as printed circuit boards and associated components, from exposure to ambient conditions.

The selection of such conventional conformal coatings is generally based upon a compromise between the hardness of the coating and its associated resistance to certain compounds, such as salt water, body fluids and industrial chemicals. One skilled in the art further appreciates that the hardness of the coating is selected such that the coating provides protection from exposure in its ambient environment, yet the coating must maintain enough compliance to avoid imposing mechanical stress to any attached components that may detach as a result of thermal expansion differentials during thermal cycles. That is, a compromise must occur regarding the barrier properties of the conventional conformal coating in view of the stiffness of the coating.

More specifically, the conformal coating generally forms an adhesive bond with the substrate. For example, in an electronics assembly, the conformal coating substantially covers the components and the printed circuit board. Due to the rigidity of the conformal coating, differences in thermal expansion of the components and the printed circuit board are translated as mechanical stress on the interface between the components and the printed wiring board. These stresses may be sufficient enough to detach or remove the components from the board. As previously mentioned, even though conventional conformal coatings maybe relatively rigid, studies show they are not sufficiently rigid to mitigate conductive crystalline structure or whisker growth.

Accordingly, it may be desirable to provide an improved conformal coating system and/or method which may mitigate the effects of conductive crystalline growth on substrates such as electronics assemblies, industrial components, medical devices, and other substrates and/or devices.

### SUMMARY OF THE INVENTION

In a first embodiment, a conformal coating comprising a binding layer and/or matrix and a particulate such that the particulate comprises an electrically non-conductive material that inhibits growth of a conductive crystalline structure.

In another embodiment, a method to coat a substrate with a conductive crystalline structure shield comprises providing a binding layer and a particulate in a multi-phase coating and applying the coating to the substrate. The particulate is distributed in a manner such that an electrically non-conductive material inhibits conductive crystalline structure growth within the substrate.

### BRIEF DESCRIPTION OF THE DRAWINGS

The features of this invention which are believed to be novel are set forth with particularity in the appended claims. The invention may be best understood by reference to the following description taken in conjunction with the accompanying drawings wherein like reference numerals identify like elements in the several figures, in which:

FIG. 1 is a photomicrograph showing tin whisker growth on an electrical conductor;

FIG. 2A is a photomicrograph showing an example conformal coat comprising glass microspheres embedded in a binding layer;

FIG. 2B is a graphic illustration of an example conformal coat comprising particulate embedded in a binding layer; and

FIG. 3 is a photomicrograph showing an electronics assembly coated with an example conformal coating.

### DETAILED DESCRIPTION OF THE PREFERRED EMBODIMENTS

While the invention described and disclosed is in connection with certain embodiments, the description is not intended to limit the invention to the specific embodiments shown and described herein, but rather the invention is intended to cover all alternative embodiments and modifications that fall within the spirit and scope of the invention as defined by the claims included herein as well as any equivalents of the disclosed and claimed invention. A conformal coating in accordance with the disclosed example of the present invention may protect device components from, for example moisture, fungus, dust, corrosion abrasion and other environmental stresses. The present coatings conform to many shapes such as, for example, crevices, holes, points, sharp edges and points or flat surfaces. In general, it has been discovered that a conformal coating constructed in accordance with the teachings of the present invention imparts shielding to a substrate and/or any attached components from the growth of metallic and/or conductive crystalline structures. In accordance with an aspect of the present invention, the disclosed conformal coatings comprise a binding layer having a non-conductive particulate with a hardness and/or density sufficient to form a tortuous path that inhibits the growth of the crystalline structures, or that may otherwise block or deflect the growth of the crystalline structures. That is, the hard particles included in the matrix provide an indention resistance to metallic crystalline structures, thus blunting and/or causing them to buckle due to side loads imparted by the tortuous path. If a metallic crystalline structure forms and initially penetrates the present conformal coating, it must continue to grow in the form of a long and slender structure in order to reach another conductor where it could cause an electrical short circuit. With the present conformal coating, adjacent conductors are protected from the columnar formations as the growth or formation may not penetrate the hard particles as its slender, columnar geometry is prone to buckle according to Euler's law.

In accordance with the disclosed example, the conformal coating may minimize or eliminate the barrier-stiffness issue and may solve the problem of conductive crystalline structure growth by providing a multi-phase conformal coating that includes a binding layer and a particulate. As previously described, selection of the binding layer—from conventional conformal coatings—provides a preferred protection from environmental contaminants without damaging the substrate and/or the interconnections between substrate components. Additionally, the particulate provides hardness and/or density sufficient to interrupt, deflect, and/or prevent growth of conductive structures, such as whiskers or dendrites.

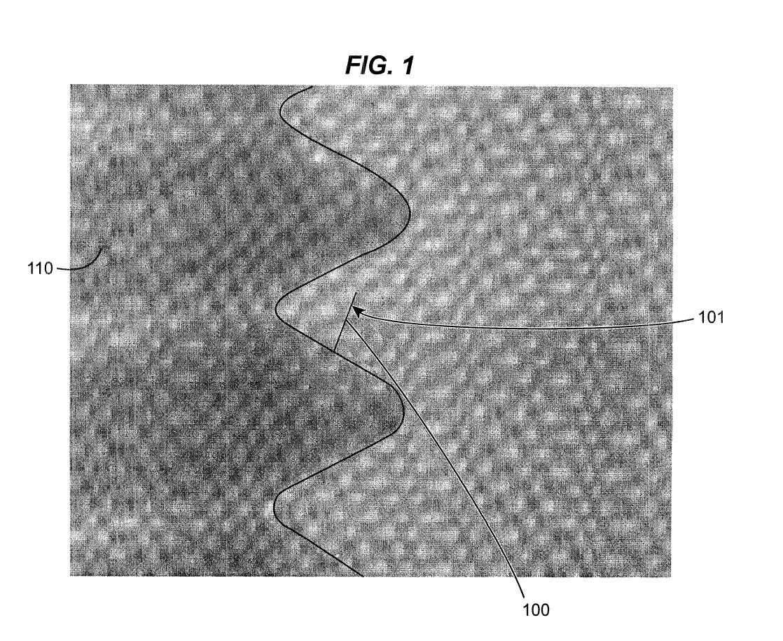

As shown in FIG. 1, a metallic whisker 100 is growing directly from the surface of an electric conductor 110. In the example of FIG. 1, the electrical conductor is a screw conductor and is shown magnified. This type of conductive growth exemplified by the metallic whisker 100 may continue outward away form the electrical conductor until the whisker 100 makes electrical contact with another conductive surface. The metallic whisker 100 is merely exemplary of a conductive crystalline structure 101. Those of skill in the art will understand that the conductive crystalline structure 101 may also take the form of a dendrite.

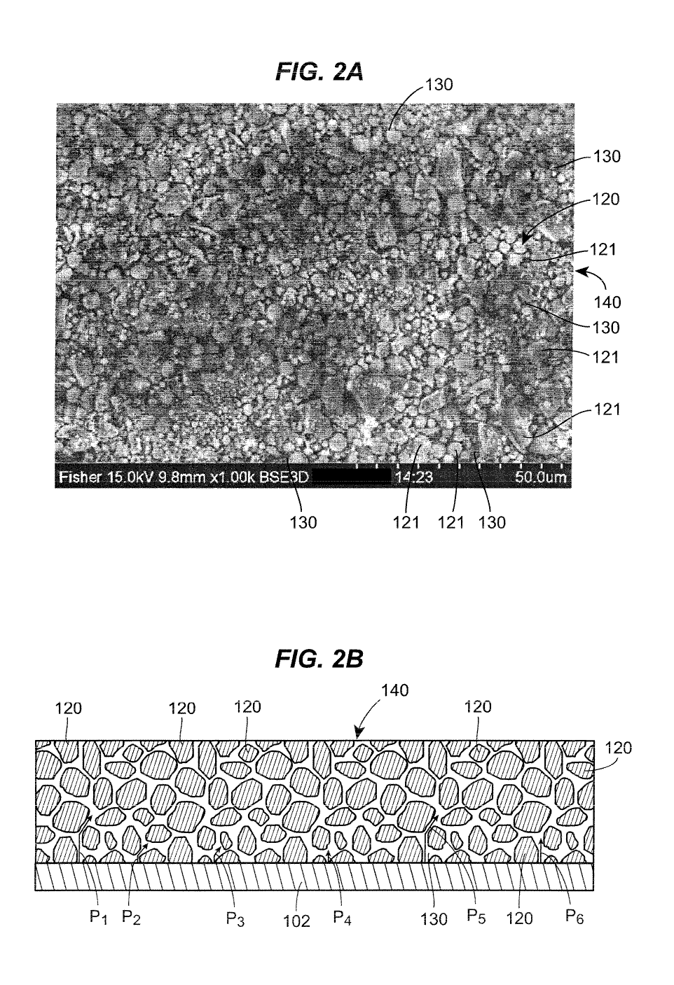

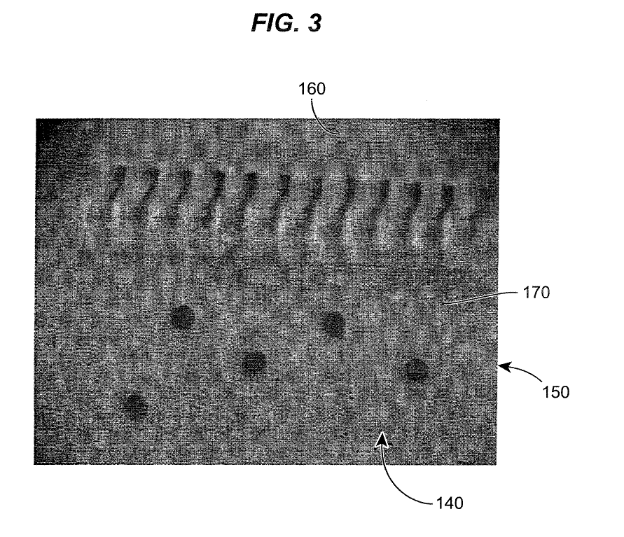

In an exemplary conformal coating 140 is shown in FIG. 2A, FIG. 2B and FIG. 3, and includes a particulate 120 embedded within a binding layer 130. As will be explained in greater detail below, the particulate 120 within the binding layer 130 conformal coating block, inhibit or otherwise obstruct the growth of the conductive crystalline structure 101. This blocking, inhibition, or obstruction may occur in at least one or two exemplary manners.

In the disclosed example, and referring to FIG. 2B, the particulate 120 is dispersed in the binding layer 130, such that the conductive crystalline structure 101 is forced to follow an tortuous path. Six (6) exemplary tortuous paths are illustrated schematically in FIG. 2B and are indicated as paths P₁, P₂, P₃, P₄, P₅ and P₆. The location and direction of these paths are exemplary only. In each case, the conductive crystalline structure 101 may propagate away from a substrate 102 to which the conformal coating 140 is applied. The conductive crystalline structure 101 will tend to follow one of the paths P₁₋₆, will encounter the particulate 120, and would have to turn in order to keep growing. Alternatively, the conductive crystalline structure 101 following one of the paths P₁₋₆ will encounter the particulate and simply be blocked from further growth by the particulate 120, because the particulate 120 has a hardness sufficient to obstruct any further growth of the conductive crystalline structure 101 (which again may be the metallic whisker 100 shown in FIG. 1 or any other conductive crystalline structure such as a dendrite).

FIG. 2A is a photomicrograph showing the present conformal coating 140 at a scale of 50 um. In the example of FIG. 2A, the particulate 120 is in the form of ceramic microspheres 121 disposed in the binding layer 130 (it will be understood that the binding layer 130 is not typically visible in an photomicrograph, so the binding layer 130 is shown schematically in FIG. 2A).

FIG. 2B is a graphical depiction also illustrating the particulate 120 in relationship to the binding layer 130. The particulate 120 is shown embedded and retained within the binding layer 130. Unlike conventional single phase conformal coatings, the particulate 120 within the binding layer 130 may be present sufficient resistance to prevent the growth of a metallic whisker and substantially prevent or eliminate any failures related thereto. It should be appreciated by one of ordinary skill in the art that the binding layer 130 may retain the particulate 120 by mechanical retention or by an adhesive bond. Further, it may be contemplated that the particulate 120 may be treated with a process, such as acid etching, to improve the retention of the particulate within the binding layer 130. The substrate 102 of FIG. 2A also may be treated to enhance adhesion by, for example, acid etching. Other treatment methods also may prove suitable.

The binding layer 130 may be a layer that comprises a conventional conformal coating selected from, for example, polyurethanes, paralene, acrylics, silicones and epoxies. It should be also appreciated by one of ordinary skill in the art that the binding layer 130 may be easily formed and applied as a dispersion of particulates alone or in combination with such solvents as acetone, water, ethers, alcohols, aromatic compounds and combinations thereof. There are several methods to apply conformal coating to substrates. Some of the methods are typically performed manually while others are automated.

Referring to FIG. 3, one example method to deposit and/or apply the present conformal coating 140 to the substrate 102 is by spray coating or painting. For example, a hand-held sprayer gun known to those skilled in the art and similar to those used to spray paint may be used to apply the conformal coating 140 to an electronics assembly board 150. As shown, an electronic component 160 and a printed wiring board 170 may be completely covered by the conformal coating 140. The freshly coated electronics assembly board 150 is allowed to cure prior to use. An example coating may comprise a binding layer available from Resinlab™ from Germantown, Wis. with particulate such as ceramic Zeeospheres® G-200, G-400 or G-600 from 3M Company of St. Paul, Minn. In an example formulation, a two part binding layer consisting of Resinlab™ W112800 epoxy using 25 ml of Part A compound, 12.5 mL of Part B compound and 25 mL of ceramic particulate, by volume, is combined with 94 mL of a thinner such as xylene. Of course, one of ordinary skill in the art appreciates that any commercially available thinner compatible with the binding layer may be used. The thinner is added to the mixture to facilitate spray deposition. For example, in this example formulation, the additional thinner provides a final mixture having a viscosity of 26 seconds in a #4 ford cup or approximately 92 centipose (cps). The spray gun used to deposit the coatings was a Model 200NH with spray tip #50-0163 from Badger Air-Brush Company of Franklin, Ill.

In the example conformal coating 140, the thinner will evaporate after application resulting in a final coating mixture of approximately 40% particulate, by volume. One of ordinary skill in the art can appreciate other alternate formulations, which could include alternate density of particulate and/or particulate of different materials of construction and/or size, as long as the cured conformal coating presents a substantial tortuous path and/or hardness to interrupt the growth of the metallic crystalline structures. Further, one of ordinary skill appreciates that alternate binding layers may include various other coatings known in the art. It is generally understood that the conformal coating material can be applied by additional various methods, such as brushing, dipping, or by needle application. The choice of application method is dependent on the complexity of the substrate to be conformally coated; the required coating performance; and the coating process throughput requirements. The coating material when dry should preferably have a thickness of in the range of 50 and 100 micrometers after curing for situations where direct condensation of moisture does not occur, although alternate thicknesses may be contemplated without departing from the spirit and scope of the invention.

Another example application method may include brushing the coating on the substrate. This may be a manual process where an operator dips a brush into a container of the coating material and brushes the material onto the substrate. The advantages of this manual process include no equipment investment, no tooling or masking is required, and the process is relatively simple. Alternatively, conventional masking techniques may be contemplated to apply the binding layer to the substrate.

Another example coating method is a dip-coating process. The dip-coating process can be done manually or automatically. In the manual mode, operators immerse a substrate, such as an electronic assembly, in a tank of coating material. Of course, this method may also be automated as understood by one of ordinary skill in the art. The advantages of this system are low capital investment, simplicity, and high throughput.

Alternatively, needle dispensing can be used to deposit the example conformal coating and may be either be done by hand or by an automated process. In a manual operation, the material is forced through a needle and is dispensed as a bead. The beads are strategically placed on the board, allowing the material to flow and coat the appropriate area. Additionally, a typical robotic process may be employed using a needle applicator that can move above the circuit board and dispense the coating material. The flow rates and material viscosity may be programmed into a computer system controlling the applicator such that desired coating thickness is maintained.

Yet another type of binding layer called paralene may be applied with the particulate to form the example conformal coating. Paralene is generally applied with a vacuum deposition process known in the art. Film coatings from 0.1 to 76.0 micrometers can be easily applied in a single operation. The advantage of paralene coatings is they cover hidden surfaces and other areas where spray and needle applications are not possible. Coating thickness is very uniform, even on irregular surfaces.

Thus, it should be appreciated by one of ordinary skill in the art that the present conformal coating comprising a binding layer and particulates in a proper proportion can be easily synthesized. At most, a few routine parametric variation tests may be required to optimize amounts for a desired purpose. The particulates may be dispersed substantially homogeneously throughout the polymeric material or may also be present in gradient fashion, increasing or decreasing in amount (e.g. concentration) from the external surface toward the middle of the material or from one surface to another, etc. Alternatively the particulates can be dispersed as an external skin or internal layer, thus forming interlaminate structures. In such an embodiment, the present particulate may be over-coated with a binding layer. In this way, the invention contemplates novel laminates or multi-layered structures comprising films of particulates over-coated with another coating or binding layer. One of ordinary skill in the art further appreciates that the particulate could be placed at individual spots or portions of the substrate with a binding layer thereon. Of course, any of these laminates can be easily formed based on the foregoing procedures.

By way of example rather than limitation, the present conformal coating may prove advantageous when applied to one or more of the following substrates: keypads, integrated circuits, printed wire boards, printed circuit boards, hybrids, transducers, sensors, accelerometers, coils, fiber optic components, heat exchangers, medical implants, flow meters, magnets, photoelectric cells, electrosurgical instruments, and encapsulated microcircuits.

While the present invention has been described with reference to specific exemplary embodiments, which are intended to be illustrative only and not to be limiting of the invention, it will be apparent to those of ordinary skill in the art that changes, additions and/or deletions may be made to the disclosed embodiments without departing from the spirit and scope of the invention. Accordingly, the foregoing description is given for clearness of understanding only, and no unnecessary limitations should be understood therefrom, as modifications within the scope of the invention may be apparent to those having ordinary skill in the art. For example, any particulate that presents sufficient hardness in the presence of the crystalline formations to create the tortuous path may prevent growth or migration. One of ordinary skill in the art should appreciate that known mineral compounds of preferably five Mohs or harder or any known material having a glass transition temperature preferably greater than four hundred Celsius may provide sufficient hardness. Although certain apparatus, methods, and articles of manufacture have been described herein, the scope of coverage of this patent is not limited thereto. To the contrary, this invention covers all apparatus, methods, and articles of manufacture fairly falling within the scope of the appended claims either literally or under the doctrine of equivalents.

What is claimed is:

1. A conformal coating comprising:
a binding layer; and
a particulate, wherein the particulate comprises an electrically non-conductive material that inhibits the growth of a conductive crystalline structure within the conformal coating.

2. The conformal coating of claim 1, wherein the particulate provides a tortuous path, the tortuous path inhibiting the growth of the conductive crystalline structure.

3. The conformal coating of claim 1, wherein the particulate is distributed within the binding layer.

4. The conformal coating of claim 1, wherein the binding layer and particulate form a laminate.

5. The conformal coating of claim 1, wherein the particulate comprises a material having a hardness of at least five on the Mohs hardness scale.

6. The conformal coating of claim 1, wherein the particulate comprises a material selected from a group consisting of silicon dioxide and ceramic.

7. The conformal coating of claim 1, wherein the electrically non-conductive particulate comprises a material preferably having a glass transition temperature of at least four hundred Celsius.

8. The conformal coating of claim 1, wherein said binding layer comprises a material selected from the group consistent of epoxy, polyurethanes, paralene, acrylics and mixtures thereof.

9. The conformal coating of claim 8, wherein the binding layer further comprises a polymeric material, wherein the polymeric material comprises a material selected from the group consisting of polyethylene, polypropylene, polyvinyl chloride, styrenic, polyurethane, polyimide, polycarbonate, polyethylene terephthalate, silicone and mixtures thereof.

10. The conformal coating of claim 1, wherein the particulate has a shape that is at least spherical, conical, cylindrical, partially spherical, partially conical, partially cylindrical and/or mixtures thereof.

11. The conformal coating of claim 2, wherein the particulate is dispersed substantially homogenously throughout the binding layer.

12. The conformal coating of claim 8, wherein the binding layer further comprises an additive selected from the group consisting of a dispersing agent, a binder, a cross-linking agent, a stabilizer agent, a coloring agent, a UV absorbent agent and combinations thereof.

13. A method of shielding the formation of conductive crystalline structures adjacent a substrate, the method comprising the steps of:
providing a conformal coating having at least a binding layer and a particulate, wherein the particulate comprises an electrically non-conductive material that inhibits conductive crystalline structure growth within the coating; and
applying the conformal coating to the substrate.

14. The method of claim 13, wherein applying the conformal coating to the substrate is selected from the group consisting of dip-coating, spray coating, brush coating, needle dispensing, vacuum deposition and/or mixtures thereof.

15. The method of claim 13, wherein the substrate is selected from the group consisting of keypads, integrated circuits, printed wire boards, printed circuit boards, hybrids, transducers, sensors, accelerometers, coils, fiber optic components, heat exchangers, medical implants, flow meters, magnets, photoelectric cells, electrosurgical instruments, and encapsulated microcircuits.

16. The method of claim 13, wherein the conformal coating provides a tortuous path that substantially inhibits growth of the conductive crystalline structure.

17. The method of claim 13, wherein the binding layer comprises a material selected from the group consisting of epoxy, polyurethanes, paralene, acrylics and mixtures thereof.

18. The method of claim 13, wherein the electrically non-conductive particulate comprises a material preferably having a hardness of at least five Mohs on the Mohs hardness scale.

19. The method of claim 13, wherein the electrically non-conductive particulate comprises a material selected from a group consisting of silicon dioxide and ceramic.

20. The method of claim 13, wherein the electrically non-conductive particulate comprises a material preferably having a glass transition temperature of at least four hundred Celsius.

21. The method of claim 13, wherein the particulate is dispersed substantially homogenously throughout the binding layer.

22. The method of claim 17, wherein the binding layer further comprises an additive selected from the group consisting of a dispersing agent, a binder, a cross-linking agent, a stabilizer agent, a coloring agent, a UV absorbent agent and combinations thereof.

23. A conformal coating assembly comprising:
a substrate at least partially covered with a conformal coating;
the conformal coating including a particulate dispersed in a binding layer, the particulate comprising an electrically non-conductive material, particulate and the binding layer arranged to limit the growth of a conductive crystalline structure propagating from the substrate.
